(19) United States
(12) Patent Application Publication
(10) Pub. No.: US 2020/0196796 A1
(43) Pub. Date: Jun. 25, 2020

(54) DUAL HEAT SOURCE BARBEQUE

(71) Applicant: Igor Shaposhnikov, Edmonton, AB (CA)

(72) Inventor: Igor Shaposhnikov, Edmonton, AB (CA)

(21) Appl. No.: 16/229,998

(22) Filed: Dec. 21, 2018

(51) Int. Cl. A47J 37/07

(52) U.S. Cl. CPC A47J 37/0709; A47J 37/0713

(57) ABSTRACT

The present invention is a novel configuration for a barbecue whereby heat sources above and below the food support structure are provided.

### BACKGROUND OF THE INVENTION

For many years, barbecue enthusiasts have enjoyed much advancement in their devices. However, there is one particular area the barbecue is lacking. Barbecues provide a single heat source below the food and food is cooked above the heat source. It has often been hypothesized that by providing heat sources above and below food, a chef can better control the cooking process. The present invention addresses this need.

### SUMMARY OF THE INVENTION

Most barbeques cook from the bottom and heat distribution can be very uneven and meat has to be watched and flipped so as to prevent burning caused by flare-ups from oil etc. leaking from the meat. This oil can drip and burn creating harmful byproducts and potential carcinogens that can be very unhealthy. By applying controlled heat from the top a user can avoid creating those harmful carcinogens. Applying controlled heat from both the top and bottom this new barbeque sears the meat and cooks more evenly with less flavor and oil loss for a more healthy finished product.

This barbeque has regular heating from the top but also has an electric heat coming in from the bottom as well. Bottom heat could be standard gas or even electric, top heat would be electric. This allows the meat (seafood, fish, vegetables, mushrooms, etc.) to be easily seared which seals in the flavor and releases fewer potential carcinogens and other unhealthy byproducts. Takes less time to cook and had much better and more even heat. Easier to clean as less juice is lost in cooking. Top heating element could have a heat shield easily applied to prevent barbeque top from getting too warm to touch.

In one embodiment, the present invention is a barbeque comprising:
a main body having a cavity formed therein;
a lid having a cavity formed therein;
a food support structure;
a lower heat source positioned below said food support structure in said main body cavity;
an upper heat source positioned above said food support structure and within said lid cavity; and independent controls for each of lower heat source and upper heat source.

In one embodiment, the invention further comprises a heat plate positioned in said lid cavity above said upper heat source.

In one embodiment, the invention further comprises an upper heat source that is at least one electric heating element.

In one embodiment, the invention further comprises an upper heat source that is at least two electric heating elements.

In one embodiment, the invention further comprises an upper heat source that is at least three electric heating elements.

In one embodiment, the invention further comprises an upper heat source that is four electric heating elements.

In one embodiment, the invention further comprises a lower heat source that is a flame fueled by a petroleum based fuel source.
In one embodiment, the invention further comprises a lower heat source that is a flame fueled by liquid propane.

In one embodiment, the invention further comprises a lower heat source that is at least one electric heating element.

In one embodiment, the invention further comprises a food support structure that is a barbeque grate.

In one embodiment, the invention further comprises food support structure are one or more skewers.

In one embodiment, the present invention is a barbeque consisting essentially of:
a main body having a cavity formed therein;
a lid having a cavity formed therein;
a food support structure;
a lower heat source positioned below said food support structure in said main body cavity;
an upper heat source positioned above said food support structure and within said lid cavity; and independent controls for each of lower heat source and upper heat source.

### BRIEF DESCRIPTION OF THE SEVERAL VIEWS OF THE DRAWINGS

FIG. 1 is a perspective view according to one embodiment of the present invention.

FIG. 2 is a perspective view showing a barbecue with an open lid according to one embodiment of the present invention.

FIG. 3 shows a barbecue with an open lid demonstrating use of a heat shield according to one of ottoman of the present invention.

FIG. 4 is an open lid of an embodiment where upper and lower heat sources are provided by heating elements.

FIG. 5 is an open lid of the embodiment of the present invention FIG. 6 shows a barbecue with an open lid demonstrating one embodiment of the present invention.

FIG. 7 demonstrates a particular embodiment of an alternative food holder namely skewers according to one bottom of the present invention.

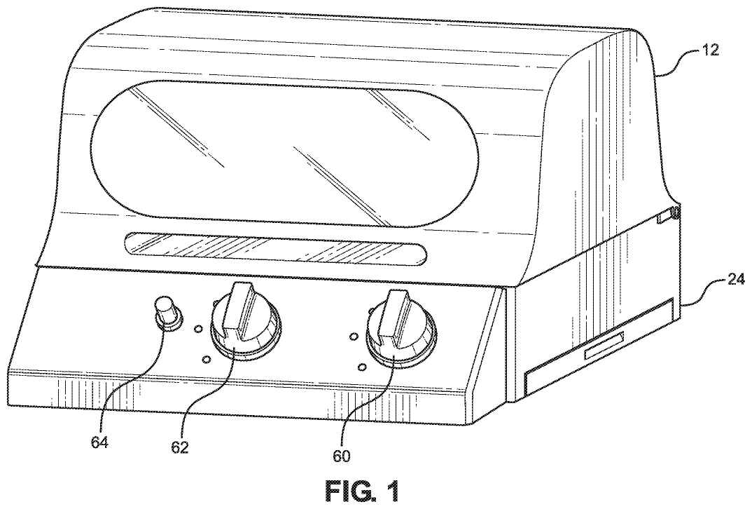

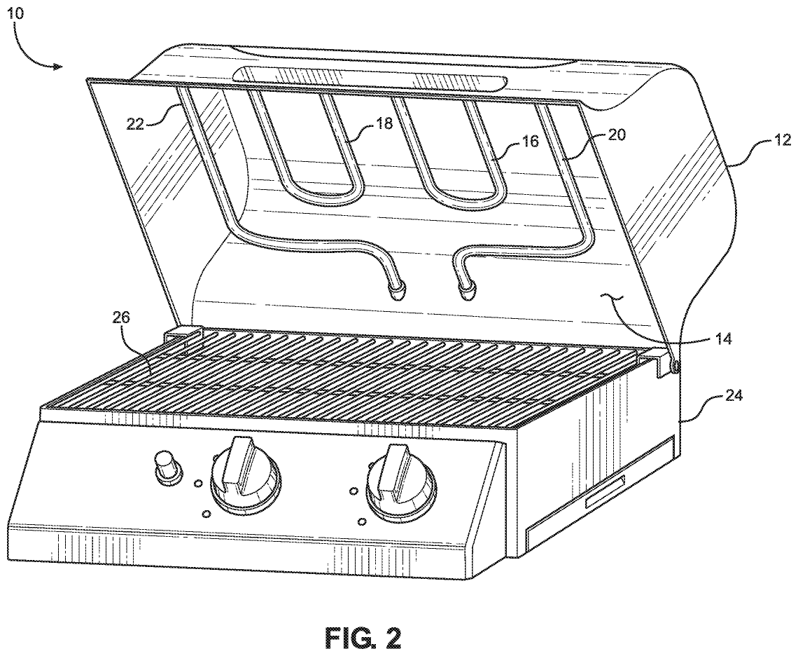

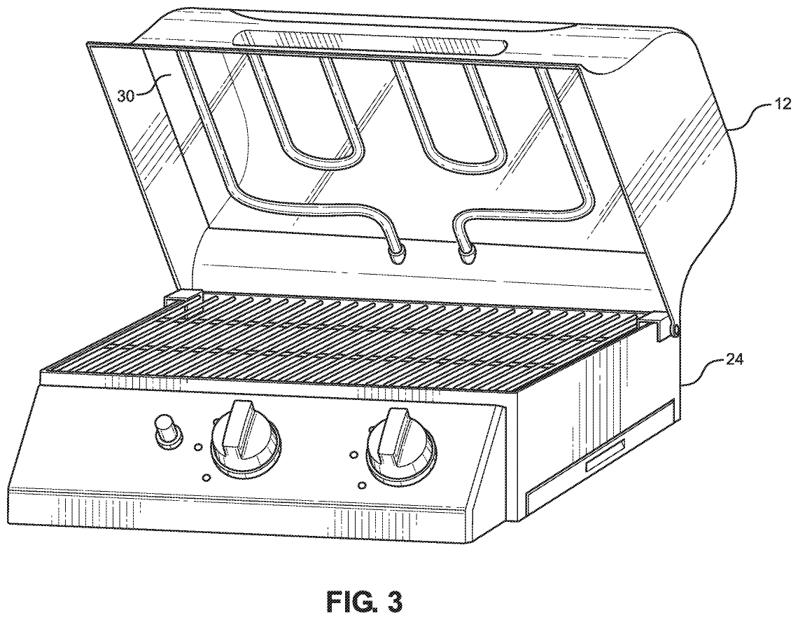

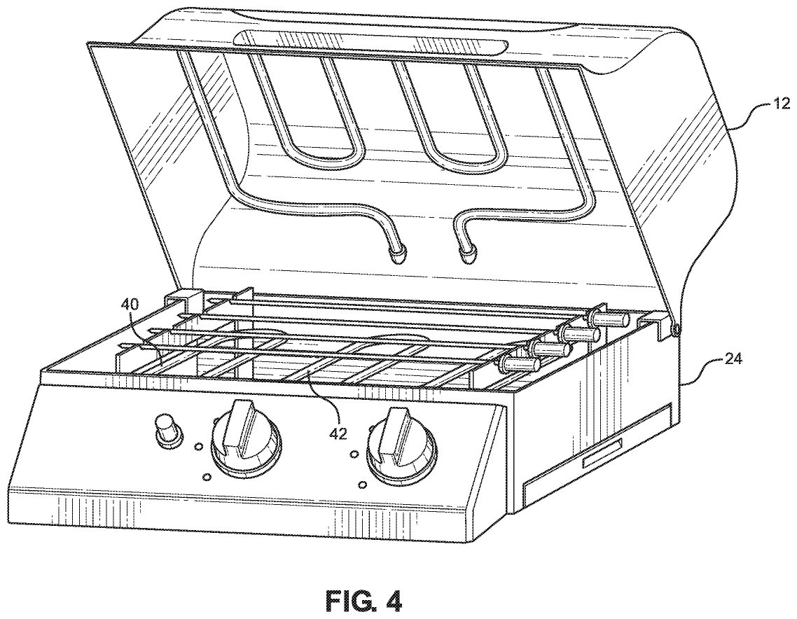

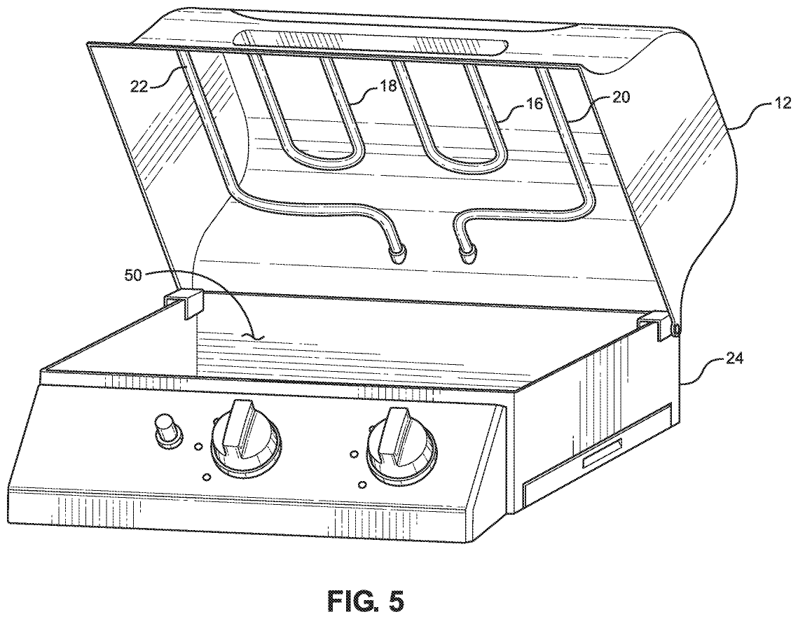

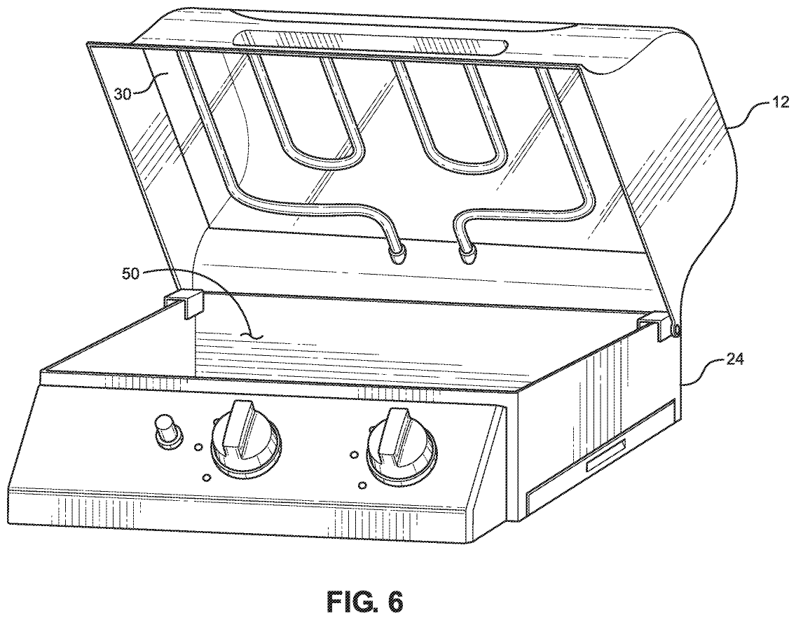

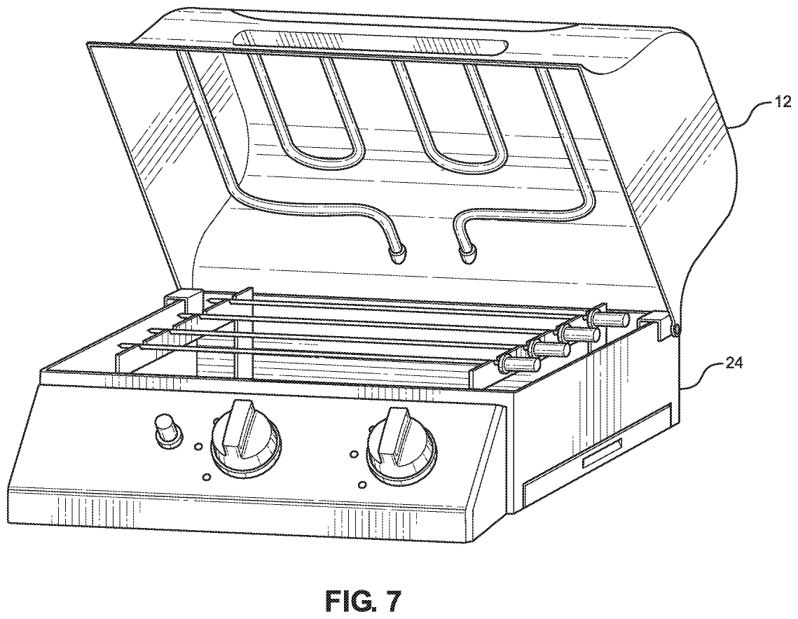

### DETAILED DESCRIPTION OF THE PREFERRED EMBODIMENT

As generally understood, barbecue system 10 is formed with a hinged cover 12 attached to a body 24. This is a common configuration amongst barbecues. Cover 12 encompasses cover cavity 14 in which upper heating elements are positioned. In one embodiment, cavity 14 contains first upper heat element 16, second upper heat element 18, third upper heat element 20 and forth upper heat element 22. Although the particular embodiment demonstrates four distinct heat elements, the impetus of the invention is positioning of a heating element above the cooked food. Therefore, configurations are one or more heat elements positioned within lid cavity 14. Additionally, in one embodiment, the one or more heat elements are optionally configured to vertically raise and lower thus varying the distanced from food being cooked on barbecue grate 26.

In one embodiment, heat plate 30 is nested within cavity 14 and is positioned above upper heating elements relative to the grate when the lid is closed. That is to say, the plate 30 is positioned between any of the upper heating elements and the top of lid 12.

As generally understood, lower heat source of any configuration emanates from within body cavity 50. As generally understood

In one embodiment, first lower heating element 40 and second lower heating element 42 are utilized. In this configuration, upper and lower sources emanate from below barbecue grate 26.

Each of first lower heating element 40 and second lower heating element 42 are precisely controlled by first control 62 and second control 64 respectively.

As generally understood, a user will initiate the production of heat from a lower heat source and an upper heat source. The lower heat source can be a petroleum-fueled flame as is currently known, an electric heating element, or combinations thereof.

A user will also initiate the production of heat from the upper heat source configured in the present invention. As discussed above, the upper heat source is configured as an electric heating element whereby between 1 to 4 elements are configured for use. Although the figures demonstrate to specific control knobs, it is contemplated that additional knobs or other structures are utilized in the present invention to independently control each particular source of heat. That is to say, that if there were four heating elements as the upper heat source and to heating elements as the lower heat source six different controls are contemplated as being utilized in the present invention. Alternatively, as shown in the figure, a single controller controls all lower heat sources, and a single controller controls all upper heat sources.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. A barbeque comprising:
a main body having a cavity formed therein;
a lid having a cavity formed therein;
a food support structure;
a lower heat source positioned below said food support structure in said main body cavity;
an upper heat source positioned above said food support structure and within said lid cavity; and independent controls for each of lower heat source and upper heat source.

2. The barbeque of claim 1 further comprising a heat plate positioned in said lid cavity above said upper heat source.

3. The barbeque of claim 1 wherein said upper heat source is at least one electric heating element.

4. The barbeque of claim 1 wherein said upper heat source is at least two electric heating elements.

5. The barbeque of claim 1 wherein said upper heat source is at least three electric heating elements.

6. The barbeque of claim 1 wherein said upper heat source is four electric heating elements.

7. The barbeque of claim 1 wherein said lower heat source is a flame fueled by a petroleum based fuel source.

8. The barbeque of claim 1 wherein said lower heat source is a flame fueled by liquid propane.

9. The barbeque of claim 1 wherein said lower heat source is at least one electric heating element.

10. The barbeque of claim 1 wherein said food support structure is a barbeque grate.

11. The barbeque of claim 1 wherein said food support structure are one or more skewers.
